(19) United States
(12) Patent Application Publication
(10) Pub. No.: US 2023/0359181 A1
(43) Pub. Date: Nov. 9, 2023

(54) INFORMATION PROCESSING SYSTEM

(71) Applicant: JOHNAN Corporation, Uji-shi, Kyoto (JP)

(72) Inventors: Kozo MORIYAMA, Uji-shi (JP); Shin KAMEYAMA, Uji-shi (JP); Truong Gia VU, Uji-shi (JP); Lucas BROOKS, Uji-shi (JP)

(73) Assignee: JOHNAN Corporation, Uji-shi, Kyoto (JP)

(21) Appl. No.: 18/026,294

(22) PCT Filed: Mar. 18, 2022
(86) PCT No.: PCT/JP2022/012497

§ 371 Date: Mar. 14, 2023

(30) Foreign Application Priority Data
Mar. 31, 2021 (JP) 2021-059275

(51) Int. Cl. G05B 19/418

(52) U.S. Cl. CPC G05B 19/41875

(57) ABSTRACT

An information processing system includes: an action acquisition device acquiring an action of a worker who performs work on a workpiece; an appearance inspection device inspecting an appearance of the workpiece after completion of the work by the worker; a database storing the action of the worker that is acquired by the action acquisition device and an inspection result by the appearance inspection device in an associated manner; and an information processing device estimating a correlation between the action of the worker and the inspection result based on information accumulated in the database.

### TECHNICAL FIELD

The present invention relates to an information processing system.

### BACKGROUND ART

Conventionally, a system to detect and report an abnormal action of a worker is known (for example, see Patent Document 1).

The system of Patent Document 1 includes a wearable device that acquires an action of a worker and a mobile computer that detects an abnormal action of the worker. When the mobile computer detects the abnormal action of the worker, the system reports the fact to an operator terminal.

### PRIOR ART DOCUMENT

### Patent Document

[Patent Document 1] JP 2019-133385 A

### SUMMARY OF THE INVENTION

### Problem to Be Solved by the Invention

Nowadays, in order to respond to growing need for high-mix low-volume production and/or variable-mix variable-volume production, a worker often works on a complicated task in a cell production system or the like. Thus, there is a room for improvement of work quality.

The present invention was made in consideration of the above circumstances, an object of which is to provide an information processing system capable of improving the work quality.

### Means for Solving the Problem

An information processing system of the present invention includes: an action acquisition device acquiring an action of a worker who performs work on a workpiece; an appearance inspection device inspecting an appearance of the workpiece after completion of the work by the worker; a database storing the action of the worker that is acquired by the action acquisition device and an inspection result by the appearance inspection device in an associated manner; and an information processing device estimating a correlation between the action of the worker and the inspection result based on information accumulated in the database.

With the above-described configuration, it is possible to encourage improvement in the work quality by giving the worker the correlation between the work of the worker and the inspection result as feedback.

In the information processing system as described above, the database may store, in addition to the action of the worker and the inspection result, data to identify the worker in an associated manner. Also, the information processing device may estimate a correlation between the action of the worker, the inspection result, and the data to identify the worker based on information accumulated in the database.

### Effects of the Invention

With the information processing system of the present invention, it is possible to improve the work quality.

### BRIEF DESCRIPTION OF THE DRAWINGS

FIG. 1 is a block diagram illustrating a schematic configuration of an information processing system according to an embodiment.

FIG. 2 is a flowchart indicating operations of the information processing system according to the embodiment.

### MODE FOR CARRYING OUT THE INVENTION

Hereinafter, an embodiment of the present invention will be described.

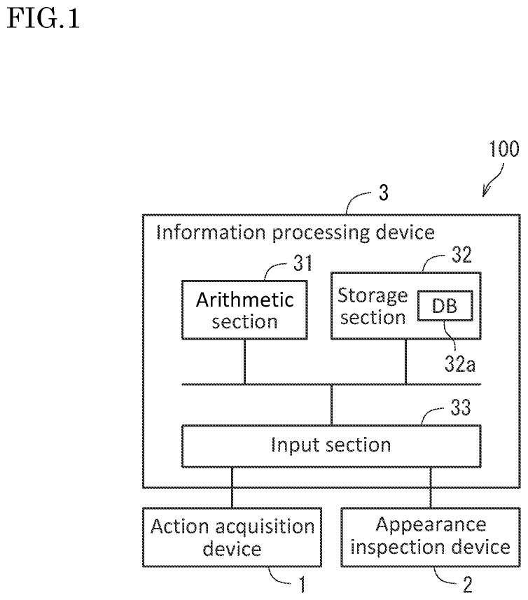

A description is given on a configuration of an information processing system 100 according to an embodiment of the present invention with reference to FIG. 1.

The information processing system 100 is configured to estimate a correlation between an action of a worker and a work result. For example, the information processing system 100 is used to manage a production site where the cell production system is adopted. As shown in FIG. 1, the information processing system 100 includes: an action acquisition device 1; an appearance inspection device 2; and an information processing device 3.

The action acquisition device 1 acquires an action of a worker who performs work on a workpiece. The action of the worker includes, for example, a location, a posture and a movement speed of the worker when the worker performs the work. The action acquisition device 1 includes a three-dimensional camera that takes images of the worker who performs the work on the workpiece, and an action estimation section to which an image result from the three-dimensional camera is input.

The three-dimensional camera is, for example, an RGB-D camera that takes an image of the worker to acquire an RGB-D image. The RGB-D image includes an RGB image (color image) and a depth image, and has depth information on each pixel on the RGB image.

The action estimation section is configured to calculate positions (three-dimensional positions) of respective sections of the skeleton of the worker based on the RGB-D images from the three-dimensional camera. Examples of the sections of the skeleton of the worker include joints such as a shoulder joint, an elbow joint and a wrist. However, the sections of the skeleton are not limited thereto. The action estimation section estimates the action of the worker based on a change over time of the respective sections of the skeleton of the worker.

The appearance inspection device 2 is provided to inspect the appearance of the workpiece after completion of work by the worker. The appearance inspection device 2 takes an image of the workpiece after completion of the work so as to perform quality judgment of the workpiece. For example, it is judged that the workpiece is a defective product when the workpiece has a scratch, a dirt or an unnecessary dent, or when a component is not appropriately mounted on the workpiece. The inspection result by the appearance inspection device 2 includes not only the quality of the workpiece, but also a defective content of the workpiece when it is a defective product.

The information processing device 3 associates the action of the worker with the inspection result to store them in a DB (database) 32a, and estimates the correlation between the action of the worker and the inspection result based on information accumulated in the DB 32a. Thus, it is possible to encourage improvement in the work quality by giving the worker the estimated correlation as feedback. For example, when there is a high correlation between a certain action of the worker (for example, a manner of using a tool by the worker, and a manner of holding the workpiece by the worker) and the defect occurrence, the worker is encouraged to modify the certain action by means of modification of work instructions and the like. In the work instructions after modification, an action replaceable with the certain action and having a high correlation with the good quality is defined. As to the thread fastening work as a specific example, when fastening by the left hand indicates a high correlation with the defect occurrence while fastening by the right hand indicates a high correlation with the good quality, the thread fastening is defined in the work instructions as a task to be performed by the right hand. Thus, it is possible to define the work procedure in detail.

Also, the information processing device 3 includes: an arithmetic section 31; a storage section 32; and an input section 33. The arithmetic section 31 controls the information processing device 3 by executing arithmetic processing based on programs and the like stored in the storage section 32. The storage section 32 stores: the programs to estimate the correlation; the DB 32a; and the like. The input section 33 is connected to the action acquisition device 1 and the appearance inspection device 2. To the input section 33, the actions of the worker are input from the action acquisition device 1, and the inspection results by the appearance inspection device 2 is also input. In the DB 32a, at least the action of the worker and the inspection result are set as columns (items), many records can be stored.

### Operations of Information Processing System

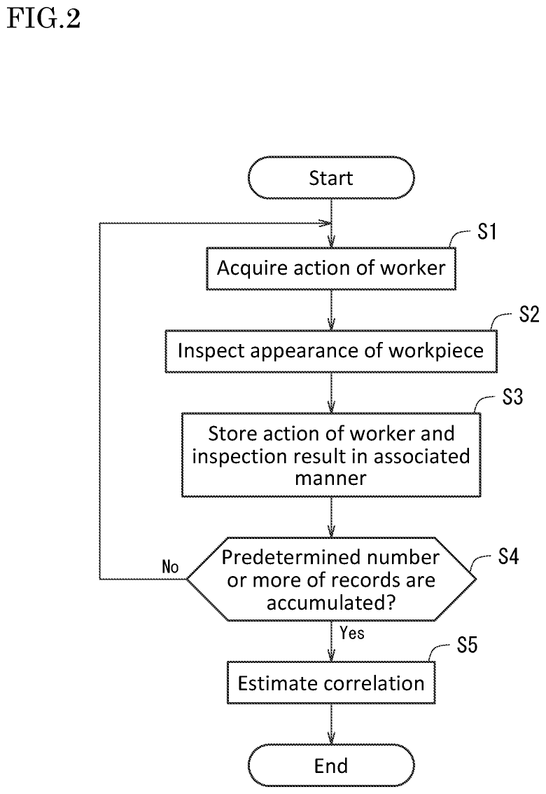

Here, the operations of the information processing system 100 according to this embodiment is described with reference to FIG. 2.

First, in step S1 in FIG. 2, the action acquisition device 1 acquires the action of the worker who performs work on the workpiece. The action of the worker acquired by the action acquisition device 1 is output to the information processing device 3.

Next, in step S2, the appearance inspection device 2 inspects the appearance of the workpiece after completion of the work by the worker. That is, the quality of the workpiece after completion of the work is judged. The inspection result by the appearance inspection device 2 is output to the information processing device 3.

Next, in step S3, the information processing device 3 associates the action of the worker with the inspection result so as to store them in the DB 32a. Thus, a record is added to the DB 32a.

Next, in step S4, it is determined whether a predetermined number or more of records are accumulated in the DB 32a. The predetermined number is, for example, a number set in advance, which is a minimum number necessary to estimate the correlation between the action of the worker and the inspection result. When the predetermined number or more of records are accumulated in the DB 32a, the procedure advances to step S5. On the other hand, when the predetermined number or more of records are not yet accumulated in the DB 32a, the procedure returns to step S1 so as to accumulate the records.

Then, in step S5, the information processing device 3 estimates the correlation between the action of the worker and the inspection result. The estimated correlation is given to the worker as feedback.

### Effects

In this embodiment as described above, the action of the worker and the inspection result are associated and accumulated so that the correlation between the action of the worker and the inspection result is estimated. Thus, it is possible to encourage improvement in the work quality by giving the worker the estimated correlation as feedback. For example, when there is a high correlation between a certain action of the worker and the defect occurrence, the worker is encouraged to modify the certain action by means of modification of work instructions and the like. As a result, it is possible to reduce defect occurrence.

### Other Embodiments

The foregoing embodiment is to be considered in all respects as illustrative and not limiting. The scope of the invention is indicated by the appended claims rather than by the foregoing description, and all modifications and changes that come within the meaning and range of equivalency of the claims are intended to be embraced therein.

For example, in the above embodiment, the information processing device 3 includes the DB 32a. However, the present invention is not limited thereto. The information processing device and the DB may be separately provided.

Also in the above-described embodiment, the action acquisition device 1 may identify the worker. In this case, in addition to the action of the worker and the inspection result, the worker ID to identify the worker is associated and stored in the DB 32a. That is, the columns in the DB 32a may include the worker ID. Thus, the information processing device 3 may estimate the correlation between the action of the worker, the inspection result and the worker ID based on the information accumulated in the DB 32a. With this configuration, it is possible to grasp a tendency for each worker and thus to provide a suitable guidance for each worker. In place of the worker ID, the name of the worker may be stored in the DB 32a. The worker ID or the name of the worker is an example of “data to identify the worker” of the present invention.

Also in the above-described embodiment, the action acquisition device 1 may have a camera for taking images of the worker, while the appearance inspection device 2 may have a camera for taking images of the workpiece. That is, the above cameras may be provided separately from each other. Alternatively, the action acquisition device 1 and the appearance inspection device 2 may share one camera.

Also in the above-described embodiment, the determination in step S4 in the flowchart in FIG. 2 may be performed by a user who uses the information processing system 100, or may be performed by the information processing device 3.

### Industrial Applicability

The present invention may be suitably applied to an information processing system.

### Description of the Reference Numerals

1 Action acquisition device

2 Appearance inspection device

3 Information processing device

32a DB (database)

100 Information processing system

1. An information processing system comprising:
an action acquisition device acquiring an action of a worker who performs work on a workpiece;
an appearance inspection device inspecting an appearance of the workpiece after completion of the work by the worker;
a database storing the action of the worker that is acquired by the action acquisition device and an inspection result by the appearance inspection device in an associated manner; and
an information processing device estimating a correlation between the action of the worker and the inspection result based on information accumulated in the database.

2. The information processing system according to claim 1, wherein
the database stores, in addition to the action of the worker and the inspection result, data to identify the worker in an associated manner, and
the information processing device estimates a correlation between the action of the worker, the inspection result, and the data to identify the worker based on information accumulated in the database.
